(19) United States
(12) Patent Application Publication
(10) Pub. No.: US 2004/0001496 A1
(43) Pub. Date: Jan. 1, 2004

(54) Method and apparatus for PPP auto-connect

(76) Inventors: Jon Yusko, Raleigh, NC (US); Timothy W. Broad, Cambridge (GB)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(21) Appl. No.: 10/064,226

(22) Filed: Jun. 21, 2002

(51) Int. Cl. H04L 12/28; H04L 12/56

(52) U.S. Cl. 370/401; 370/469

(57) ABSTRACT

Various implementations for providing transparent connectivity between local area networks (LANs) and wide area networks (WANs) are disclosed herein. A customer premise access equipment (CPE) can be adapted to automatically establish a physical transport layer connection with one or more remote access concentrators on a WAN when an outgoing data packet intended for a device on the WAN is received from a network device located on a LAN. Additionally, in at least one embodiment, the CPE includes a packet filter to prevent certain data packets, such as packets intended for the CPE, from initiating an automatic connection, where the packet filter can be adapted to filter the packets based on the ports associated with the packets.

### BACKGROUND OF THE INVENTION

The present invention relates generally to point-to-point data communication and more particularly to automatically establishing a physical connection between a customer premise access equipment and an access concentrator for the transmission of data.

The Point-to-Point Protocol (PPP) has become the default standard for connecting broadband customer premise access equipment (CPE), such as modems and routers, to remote access concentrators (e.g., dial-up connections maintained by internet service providers, or ISPs). PPP, as detailed by request for comments (RFC) 1548, describes a process for transporting IP packets over a physical link, incorporating error correction, diagnostics, security, and peer-to-peer negotiation. Likewise, PPP-based protocols, such as the PPP over Ethernet (PPPoE) protocol, the PPP over Asynchronous Transfer Mode (PPPoA) protocol, and the PPP over HDLC protocol, are widely implemented protocols for PPP encapsulation over wide area network (WAN) interfaces.

PPP and PPP-based protocols are particularly useful in communications between network devices on a local area network (LAN) and remote network devices located on a WAN. In such cases, one or more network devices typically are connected to a CPE via any of a number of types of LANs, such as an Ethernet or ATM network. In turn, the CPE is connected to an access concentrator of the WAN via one or more physical network mediums, such as twisted pair cable, coaxial cable, fiber optics, wireless transmission devices, and the like. To transmit data from the network device of the LAN to the remote device on the WAN, a user of a network device typically directs the PPP protocol layer of the CPE to establish a physical transport layer connection (physical connection herein) to the access concentrator over the physical network medium. The physical connection process performed by the PPP stack generally includes providing a user-supplied identification (ID) and password from the CPE to the access concentrator, providing authentication information, receiving notification from the access concentrator that a link is established, and the like. Additionally, the user typically is required to explicitly direct the CPE to initiate the connection process. After the physical connection is established based on user direction, the CPE provides packets from the network device to the access concentrator, and vice versa, over the established physical connection. When the user desires to terminate the connection, the user may direct the CPE to disconnect the physical link with the access concentrator. Alternatively, the PPP stack may implement a time out mechanism to automatically disconnect the CPE from the access concentrator after a certain time period of inactivity by the network device.

While it is often desirable to disconnect the CPE from the access concentrator during periods of inactivity, the user typically is burdened with the additional effort of redirecting the PPP stack to reestablish the physical connection with the access concentrator each time the physical connection is disconnected. To illustrate, dial-up connections implementing PPP typically require the user to provide a user ID and password and to manually direct the CPE (a dial-up modem in this example) to initiate the connection process with the user-supplied information. Continually and repeatedly providing this information every time a user desires to establish a connection often is inconvenient and distracting to the user.

Accordingly, an improved process for establishing PPP-based connectivity would be advantageous.

### SUMMARY OF THE INVENTION

The present invention mitigates or solves the above-identified limitations in known solutions, as well as other unspecified deficiencies in known solutions. A number of advantages associated with the present invention are readily evident to those skilled in the art, including economy of design and resources, transparent operation, cost savings, etc.

Various embodiments of the present invention described herein allow the user to make a physical layer transport connection from a LAN to a WAN by transmitting IP traffic to the PPP protocol layer of a CPE from the LAN side. The incoming IP traffic, in turn, is translated by the PPP protocol layer, which recognizes the need for a new physical connection and proceeds to connect the CPE to the WAN using a preexisting or predetermined configuration, but with virtually no additional user intervention. Also implemented in various embodiments is a dynamically configurable protocol filter packet for the CPE. The protocol filter allows the user to configure and prevent the packets of a specific networking protocol from initiating the PPP auto-connect process in the CPE, thereby preventing certain protocols used in networking (such as Address Resolution Protocol or Simple Network Management Protocol) from initiating an unwanted LAN to WAN connection.

In a distributed network including at least one LAN having a network device and a WAN having an access concentrator, a CPE is provided in accordance with one embodiment of the present invention. The CPE comprises a first interface operatively connected to the network device and being adapted to receive at least one data packet from the network device and a second interface operatively connected to the access concentrator and being adapted to provide at least one data packet to the access concentrator for transmission to the wide area network. The customer premise access equipment further comprises an auto-connect module operably connected to the first interface and the second interface and being adapted to automatically establish a physical connection between the second interface and the access concentrator based at least in part on reception of a data packet intended for the wide area network by the customer premise access equipment.

In a communications processor for processing data transmitted between a network device of a local area network and an access concentrator of a wide area network, a network protocol stack is provided in accordance with another embodiment of the present invention. The network protocol stack comprises at least one higher-level protocol layer, at least one lower-level protocol layer, and a Point-to-Point Protocol (PPP) layer operably connected to the at least one higher-level protocol layer and the at least one lower-level protocol layer. The PPP layer is adapted to receive a data packet from the network device via the higher-level protocol layer, determine an intended destination of the packet based at least in part on a port used to receive the packet from the network device, and automatically establish a physical connection with the access concentrator when the wide area network is the intended destination of the packet.

In accordance with yet another embodiment of the present invention, a method for communicating data from a network device of a local area network to an access concentrator of a wide area network using a customer premise access equipment is provided. The method comprises the steps of receiving, at a port of the customer premise access equipment, a data packet from the network device, determining an intended destination of the data packet based at least in part on the port, automatically establishing a physical connection between the customer premise access equipment and the access concentrator for transmission of the packet when the intended destination is the wide area network.

In a network protocol stack of a customer premise access equipment for processing data transmitted between a network device of a local area network and an access concentrator of a wide area network, the network protocol stack including at least a Point-to-Point Protocol (PPP) layer, a method is provided in accordance with an additional embodiment of the present invention. The method comprises the steps of receiving, at the PPP layer, a data packet from the network device via a port of a higher-level protocol layer of the network stack, determining, at the PPP layer, an intended destination of the first data packet based at least in part on the port, automatically establishing a physical connection between the customer premise access equipment and the access concentrator when the intended destination of the data packet is the wide area network.

In a customer premise access equipment for processing data transmitted between a network device of a local area network and an access concentrator of a wide area network, a computer readable medium is provided in accordance with another embodiment of the present invention. The computer readable medium comprises a set of executable instructions adapted to manipulate a processor to receive a data packet from the network device via an available port of the customer premise access equipment, determine an intended destination of the first data packet based at least in part on the port, and automatically establish a physical connection between the customer premise access equipment and the access concentrator when the intended destination of the data packet is the wide area network.

One advantage of the present invention includes simplified user connectivity between a local area network and a wide area network. Another advantage includes decreased user effort to establish a physical connection.

Still further features and advantages of the present invention are identified in the ensuing description, with reference to the drawings identified below.

### BRIEF DESCRIPTION OF THE DRAWINGS

The purpose and advantages of the present invention will be apparent to those of ordinary skill in the art from the following detailed description in conjunction with the appended drawings in which like reference characters are used to indicate like elements, and in which:

FIGS. 1A-1C are schematic diagrams illustrating an exemplary implementation of a distributed network having a customer premise access equipment (CPE) adapted to automatically establish a physical transport layer connection with an access concentrator in accordance with at least one embodiment of the present invention;

FIG. 2 is a schematic diagram illustrating the customer premise access equipment of FIG. 1 in greater detail in accordance with at least one embodiment of the present invention; and

FIG. 3 is a schematic diagram illustrating an exemplary implementation of a network protocol stack adapted to automatically establish a physical transport layer connection with an access concentrator in accordance with at least one embodiment of the present invention.

### DETAILED DESCRIPTION OF THE INVENTION

The following description is intended to convey a thorough understanding of the present invention by providing a number of specific embodiments and details involving point-to-point data transmission in networks. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

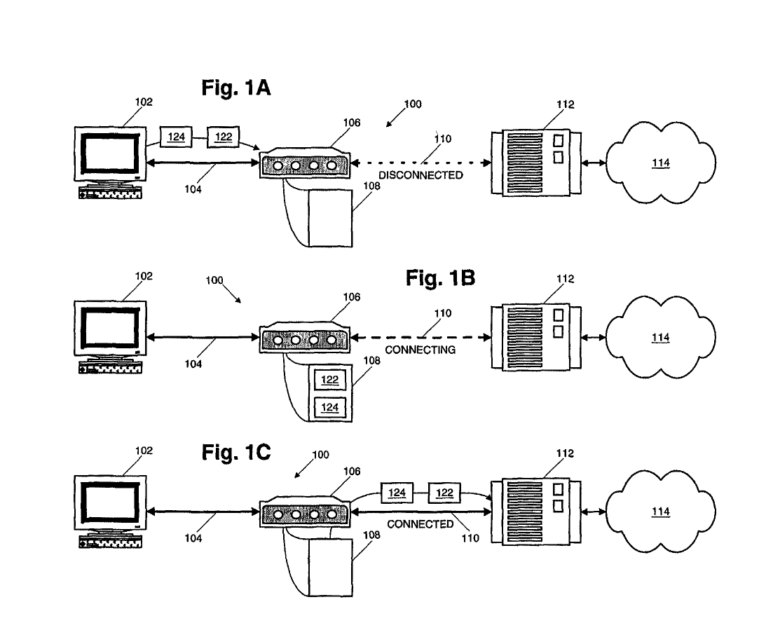

FIGS. 1-3 illustrate exemplary embodiments for providing transparent connectivity between local area networks (LANs) and wide area networks (WANs). In at least one embodiment, a PPP protocol stack of a customer premise access equipment (CPE) is adapted to automatically establish a physical transport layer connection (i.e., physical connection) with one or more remote access concentrators on a WAN when an outgoing data packet intended for a device on the WAN is received from a network device located on a LAN. Additionally, in at least one embodiment, the network protocol stack includes a packet filter to prevent certain data packets, such as packets intended for the CPE, from initiating an automatic connection, where the packet filter can be adapted to filter the packets based on the ports associated with the packets.

Referring now to FIGS. 1A-1C, an exemplary network system 100 is illustrated in accordance with at least one embodiment of the present invention. The system 1 00, as shown, includes at least one network device 102 connected via network medium 104 to a customer premise access equipment (CPE) 106 that is connected to an access concentrator 11 2 via network medium 110. The access concentrator 112 in turn is connected to one or more networks 114 (e.g., a WAN, a LAN, the Internet, etc). The network device 1 02 can include any of a variety of network-enabled devices, such as a desktop computer, a notebook computer, a handheld wireless device, a data server, a networked printer, a router, a switch, a hub, and the like. The CPE 106 can include any of a variety of CPEs (also known as gateways) utilized as an interface between a local network (e.g., a LAN) and the access concentrator of a remote network (e.g., a WAN), such as a dial-up modem, a digital subscriber line (DSL) modem, a cable modem, a router, an optical network termination (ONT), and the like. The network medium 104 utilized for communication between the CPE 106 and the one or more network devices 102 can include any of a variety of network mediums suitable for implementation in a LAN, such as an Ethernet network, an ATM network, an IEEE 802.11b wireless network, and the like.

The access concentrator 112 can include any of a variety of access concentrator devices appropriate to the CPE 106. To illustrate, if the CPE 106 includes an analog dial-up modem, then the access concentrator 112 could include a bank of modems adapted to receive incoming calls. Likewise, if the CPE 106 includes a DSL modem, then the access concentrator typically would include a DSL access multiplexer (DSLAM). The network medium 110 connecting the CPE 106 to the access concentrator 12 can include any of a variety of wide area network mediums compatible with the CPE 106 and the access concentrator 112, such as a DSL/ATM medium, a wireless medium, and the like.

In general, known implementations of CPEs require user input before establishing a physical connection over the network medium 110. This input typically includes the user manually supplying a user ID and password, providing connection settings such as bit parity, and expressly directing the CPE to initiate the connection negotiations with the supplied information. However, in at least one embodiment, the CPE 106 appears to the network device 102 as having a continuously established link, regardless of an actual physical connection. As such, the network device 102 may transmit packets of data (e.g., packets 122, 124) to the CPE 106 for transmission to the network 114 via the access concentrator 112 without requiring the user to explicitly direct the CPE 106 to establish a physical connection.

24 Upon receipt of each packet, the CPE 106 is adapted to determine whether the packet is to be transmitted to the access concentrator 112. As discussed below in greater detail, the port used to receive a packet at the CPE 106 may be used to determine the intended destination of the packet. In the event that a packet is to be transmitted to the access concentrator 112, the CPE 106 determines the status of the physical connection between the CPE 106 and the access concentrator 112. If a physical connection is established, then the CPE 106 can forward the packet to the access concentrator 112 over network medium 110. In the event that a physical connection is not established at the time of the receipt of a packet from the network device 102, the CPE 106 is adapted to automatically establish a physical connection with the access concentrator 112 with little or no input from the user of the network device 102.

The term automatically establish a physical connection, as used herein, refers to a process (herein referred to as the auto-connect process) of initiating and negotiating a physical connection between the CPE 106 and the access concentrator 112 without express direction to do so from the user or input from the user. To illustrate, rather than requiring the user to provide, for example, a user ID and/or password each time the user attempts a data transfer when a link does not exist between the CPE 106 and the access concentrator 112, the CPE 106, in one embodiment, is adapted to detect the attempted transmission and to initiate the establishment of the physical connection without requiring the user to input information, provide an express command, or otherwise manually or expressly direct the CPE 106 to establish the connection. The information necessary to automatically establish the physical connection could be generic information that is not specific to the user, or the user could provide user-specific information during, for example, an initial attempt to establish a physical connection or when first using a networking application. This user-specific information then can be stored as a user profile at the CPE 106 and used for subsequent automated attempts at establishing the physical connection.

To illustrate, referring now to FIGS. 1A-1C, assume in the following example that the user of the network device 102 desires to view a web page available from a data server on the network 114. Accordingly, the network device 102 provides packets 122, 124 (representing, for example, a Hypertext Transfer Protocol (HTTP) web page request for the desired webpage) over the network medium 104 to the CPE 106 for transmission to the access concentrator 112. In this example, a physical connection between the CPE 106 and the access concentrator 112 is not present at the time of transmission of packet 122 (FIG. 1A). Accordingly, the CPE 106, in one embodiment, is adapted to automatically initiate the establishment of a physical connection to the access concentrator 112 and to buffer each incoming packet in a packet buffer 108 in the meantime until the physical connection is established (FIG. 1B). As a result, the CPE 106 may appear to be continuously connected to the access concentrator 112 since the user is not required to provide input to initiate each auto-connect process.

After the physical connection is established between the CPE 106 and the access concentrator 112, the CPE 106, in one embodiment, is adapted to retrieve the packets 122, 124 from the buffer 108 and transmit the retrieved packets to the access concentrator 112 over the established physical connection (FIG. 1C). Thereafter, the CPE 106 can maintain the physical connection for a predetermined time to receive incoming packets from the access concentrator 114 (representing, for example, the HTTP web page file from the server on the network 114), the connection can be severed after a predetermined period of inactivity, or the connection can be severed immediately after all outgoing packets are transmitted to the access concentrator 112.

By automatically establishing the physical connection upon receipt of certain packets from the network device 102 without notifying the user or requesting direction from the user, the step of manually configuring and initiating the physical connection by the user is eliminated and/or the effort to establish the physical connection on the part of the user is substantially reduced. As a result, the time and effort necessary to transmit information from the network device 102 to the network 114 is reduced compared to known implementations requiring user input to establish or reestablish a physical connection.

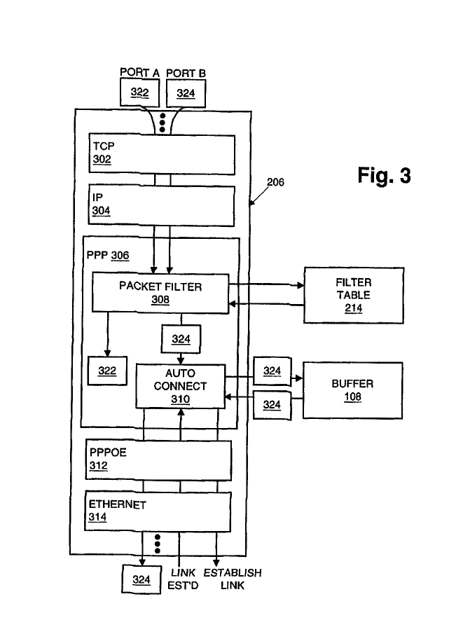

It will be appreciated that in some cases, the CPE 106 may receive packets from the network device 102 and/or generate packets that are not intended for transmission to the access concentrator 112 but rather for processing by the CPE 106 or other local device. Accordingly, in at least one embodiment, the CPE 106 further includes a packet filter (illustrated in FIG. 3) adapted to filter packets to prevent the CPE 106 from establishing a physical connection for packets intended for local use. As discussed below, the packet filter, in one embodiment, filters packets based on the port used to receive the packet. In general, each port, such as a Telecommunications Protocol (TCP) port or a User Datagram Protocol (UDP) port, is associated with a specific function of a certain network protocol. For example, TCP port 162 is commonly associated with trap packets for the Simple Network Management Protocol (SNMP) and TCP port 80 is commonly associated with HTTP requests. It will be appreciated that while some of these functions may involve the transmission of data from the CPE 106 to the access concentrator 112, other functions may be utilized solely by the CPE 106. Accordingly, the packet filter can be adapted to filter the packets based on their intended destination, either for local processing or for use by the WAN (network 114).

To demonstrate, the network device 102 may transmit an SNMP trap packet to a TCP, such as conventionally associated with TCP port 162. Since the SNMP trap packet typically is not generated as a result of a user attempting to communicate with the network 114 and instead is generally used by the CPE 106 for network management of the local network, in this case the packet filter can be configured to prevent the SNMP trap packet from initiating the automatic connection process. Conversely, the network device 102 could transmit a HTTP web page request packet to a web server on the network 14 via another port, such as conventionally associated with TCP port 80. Since the HTTP web page request is intended for the web server on the network 114, the packet filter, in this case, can be configured to direct the CPE 106 to automatically establish a physical connection to transmit the HTTP web page request packet to the web server via the access concentrator 112. Accordingly, the port by which a packet is received typically can be viewed as an indicator of the intended destination of the packet, i.e., whether the packet is intended to be forwarded to the access concentrator 112 or processed locally by the CPE 106. The packet filter is discussed in greater detail below with reference to FIG. 3.

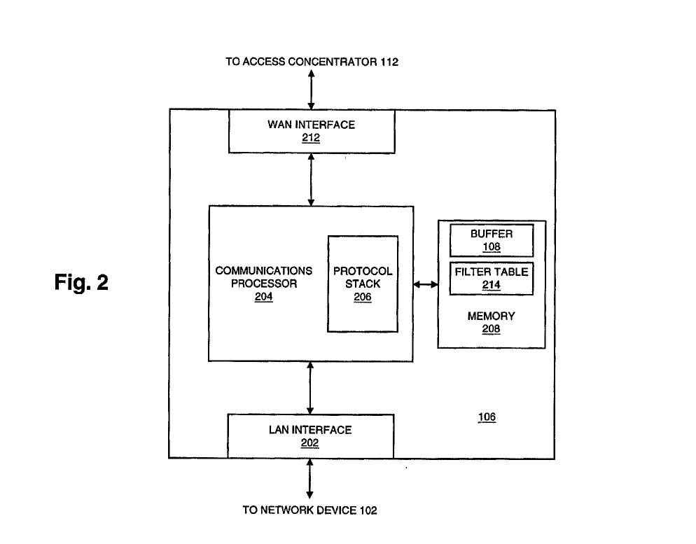

Referring now to FIGS. 2 and 3, an exemplary implementation of the CPE 106 is illustrated in greater detail in accordance with at least one embodiment of the present invention. As shown in FIG. 2, the CPE 106, in one embodiment, includes a LAN interface 202, a communications processor 204, memory 208, and a WAN interface 212. The LAN interface 202 can include any of a variety of network interfaces appropriate to the network medium 104 (FIG. 1), such as an Ethernet interface, a token ring interface, an ATM interface, a universal serial bus (USB) interface, a FireWire interface, an IEEE 802.11b interface, and the like. The WAN interface 212 can include any of a variety of network devices suitable to the network medium 110, such as a Utopia interface, an ATM over optical fiber interface, a cable modem interface, a optical line termination (OLT), a dial-up modem interface, a wireless interface, and the like. The memory 208 can include any of a variety of memory devices, such as random access memory, read-only memory, flash storage, cache, registers, disc storage, and the like. The communications processor 204 includes one or more processing devices adapted to process incoming (i.e., from the access concentrator 112) and/or outgoing (i.e., from the CPE 106) packets using a network protocol stack, such as network protocol stack 206. An exemplary implementation of communications processor 204 includes the communications processor available under the tradename HELIUM from Globespan Virata, Inc. of Red Bank, New Jersey.

In at least one embodiment, outgoing packets from the network device 102 are received at the CPE 106 via the LAN interface 202 and then provided to a network protocol stack 206 for processing in accordance with the one or more network protocols layers of the network protocol stack 206. As revealed in FIG. 3, the network protocol stack 206, in at least one embodiment, may include one or more higher-level protocol layers, such as, for example, a TCP layer 302, an Internet Protocol (IP) layer 304, a PPP layer 306, and one or more lower-level protocol layers, such as PPPoE layer 312, Ethernet layer 314, and the like. Although an exemplary implementation of the network protocol stack 206 having the above combination of protocol layers is illustrated for ease of discussion, it would be well understood by one skilled in the art to use other protocol layers and/or combinations thereof without departing from the spirit or the scope of the present invention. For example, an ATM layer could be utilized rather than the Ethernet layer 314 or a UDP layer could be utilized rather than the TCP layer 302, using the guidelines provided herein. Likewise, although PPP layer 306, in one embodiment includes a protocol layer based on the PPP protocol (RFC 1548), other point-to-point protocols may be utilized in accordance with the present invention, such as the Serial Line Internet Protocol (RFC 1055) or the High-Level Data Link Control (HDLC) protocol, and the like.

The network protocol stack 206 processes each incoming packet at each protocol layer until the packet (or its derivative) is received by the PPP layer 306. In at least one embodiment, the PPP layer 306 includes a packet filter 308 adapted to filter the packets to prevent undesired or unnecessary attempts at automatically establishing a physical connection. If the packet filter 308 determines that a device on the network 114 is the intended destination of a certain packet based on the port used to receive the packet, the packet filter 308, in one embodiment, directs the auto-connect module 310 of the PPP layer 306 to initiate the establishment of a physical connection for transmission of the packet. For incoming packets having the CPE 106 or other local device as their intended destination, the packet filter 308, in one embodiment, bypasses auto-connect module 310 and provides the packet to the remaining layers for processing as usual.

Upon receipt of the signal from the packet filter 308, the auto-connect module 310, in one embodiment, is adapted to determine the status of the physical connection between the CPE 106 and the access concentrator 112 over the network medium 110. If a connection exists, the auto-connect module 310 directs the packet to be processed by the subsequent layers of the network protocol stack 206 and then transmitted to the access concentrator 112 via the WAN interface 212. If the auto-connect module 310 determines that a physical connection is unavailable, the auto-connect module 310 initiates the establishment of a physical connection between the CPE 106 and the access concentrator 112.

During the establishment of the physical connection, the auto-connect module 310, in one embodiment, is further adapted to queue the packet and subsequently received packets in the buffer 1 08 until the physical connection is established. Once the connection is established, the auto-connect module 310 can retrieve each packet from the buffer 108 and provide the packet to the remaining layers of the network protocol stack 206 for processing and subsequent output to the access concentrator 112 via the established connection.

To illustrate the operation of the network protocol stack 206, consider the following example whereby packets 322, 324 are transmitted from the network device 102 to the CPE 106. In this example, the packet 322 represents a packet for local use, such as an Address Resolution Protocol (ARP) timeout packet, and the packet 324 represents a request for an HTTP web page from a HTTP server located on network 114. Furthermore, assume that the packet 322 is transmitted to, for example, TCP port 60 whereas the packet 324 is transmitted to, for example, TCP port 80.

At the CPE 106, each packet is received by the LAN interface 202 and provided to the communications processor 204 for processing by the network protocol stack 206. Accordingly, each of the packets 322, 324 is processed at the TCP layer 302 and the IP layer 304 as in typical protocol stacks. At the PPP layer 306, each packet is provided to the packet filter 308 to determine if the auto-connect module 310 should automatically establish/reestablish a physical connection to transmit the packet. In at least one embodiment, the packet filter 308 utilizes a filter table 214 (implemented, for example, in memory 208) to determine if a packet received via a certain port is enabled to initiate the auto-connect process. For example, the filter table 214 can include a status value for each port, the status value being representative of the intended destination (i.e., CPE 106 or network 114) of packets received via the port. The packet filter 308, in this case, is adapted to determine the port associated with a packet and to retrieve the status value associated with the port from the filter table 214. Based on the intended destination represented by the status value, the packet filter 308 can either direct the to the auto-connect module 310 to initiate the auto-connect process when the status value indicates that the intended destination is the network 114 or bypass the auto-connect module 310 when the status value of the port indicates the intended destination is the CPE 106.

In at least one embodiment, the CPE 106 is implemented as part of an embedded system or system having relatively limited resources. As such, it may be desirable to limit the amount of memory required by the operation of the CPE 106. To this end, in one embodiment, the filter table 214 includes a table of multiple-bit entries, where each bit of each entry represents the status value of a different port. For example, to represent TCP ports 0-1024 and UDP ports 0-1024, the filter table 214 could include two linear arrays of 129, 8-bit entries, each entry representing 8 ports (with seven of the eight bits of the 129^{th} entry not having a corresponding port). Accordingly, the entry of the linear array associated with a certain port can be determined by dividing the port number by eight and the bit within the entry associated with the port can be obtained by taking the modulus eight of the port number. Based on the value of the indexed bit of the filter table 214, the packet filter 308 can direct the auto-connect module 310 to initiate the auto-connect process, as appropriate.

To illustrate, consider the following program routines filter_value and modify_filter_value (based on the C++ programming language):

[t1]
char port_array[129];
bool filter_value(int port_number)
{

int port_array_index;
int port_bit_index;
int port_value;
port_array_index = port_number DIV 8;
//index to the entry of the table
port_array_bit = port_number MOD 8; //bit index of the entry
port_value = port_array[port_array_index] &
(0x01 << port_array_bit);
return (port_value > 0);

} //end of return_filter_value
void modify_filter_value(int port_number, bool enable)

int port_array index;
int port_bit_index;
port_array_index = port_number DIV 8;
//index to the entry of the table
port_array_bit = port_number MOD 8; //bit index of the entry
if(enable == TRUE)
{

port_array[port_array_index] =
port_array[port_array_index] |

˜(0x01 << port_array_bit);

}
else
{

port_array[port_array_index] =
port_array[port_array_index] |

˜(0x01 << port_array_bit);

}

} // end of modify_filter_value

40 In the above program, the function return_filter_value represents the subroutine implemented by the packet filter 308 when determining if a packet received via a certain port is allowed to initiate the auto-connect process. In this example, the port number (the integer variable port_number) is supplied to the subroutine when initiated. The entry index of the port table 214 (represented by the 129 entry character array port_array[ ]) is determined by the integer division of port_number by eight (as there are eight bits per character) and the bit index (port_array_bit) of the entry corresponding to the port is determined by taking the modulus eight of port_number. To determine the value of the bit of the filter table 214 (port_array[ ]), the entry at port_array[port_array_index] is logically AND'ed with the bit value 1 shifted to the left by port_array bit places. The AND'ed value is then compared to zero. The result of the comparison (TRUE or FALSE) is returned and represents the value of the filter table 214 associated with the specified port.

To illustrate the operation of the function return_filter_value, assume that the packet filter 308 utilizes the return_filter_value function to determine the status for packets received via port 60 (port_number=60), where a returned value of 1 indicates that packets associated with a port are allowed to initiate the auto-connect process and a returned value of 0 indicates that the auto-connect process is disallowed. Accordingly, using the above program, port_array_index=7 (60 DIV 8) and port_array_bit=4 (60 MOD 8). Accordingly, the status value for port 60 is located at the fourth bit of port_array[7]. Further assume that port_array[7] has the binary value of 01001001b. Accordingly, when the value 0x01 is shifted left by 4 places (0x01<<4=0001000b) and AND'ed with port_array[7], the resulting value is 00001000b or 8 in decimal. Since eight is greater than zero, a value of TRUE is returned, thereby indicating that auto-connect process is allowed for packets associated with the port 60. Alternatively, assume that port_array[7 ] has a binary value of 01000001b. In this case, the resulting AND'ed value would be 00000000b or 0 in decimal, which is not greater than zero, resulting in a value of FALSE being returned, indicating that the auto-connect process is disallowed for packets received via port 60.

The function modify_filter_value represents the function performed to enable or disable the auto-connect process for packets received via a specified port. The enabled/disabled status of a particular port can be dynamically managed by an administrator, a user, based on a predetermined configuration, and the like. For example, an administrator could configure the network device 102 for use only in viewing web pages by enabling the TCP port 80 (for HTTP data traffic) and disabling all other ports. In this case, the administrator could modify the values of the filter table 214 using, for example, a command line interface which provides the administrator-supplied information to the modify_filter_value function. As revealed by the above program, the modify_filter_value can receive two values, the port number (port_number) and a boolean value (enable), where the boolean value TRUE indicates that the auto-connect process is to be enabled for the port number and the boolean value FALSE indicates that the auto-connect process is to be disabled. Accordingly, the value of the bit of the entry of the frame table 214 (port_array[ ]) can be enabled (i.e., have a value of 1) by OR'ing the binary value of the entry with the value 0x01 shifted left by port_array_bit places. Conversely, the value of the bit of the entry of the frame table 214 can be disabled (i.e., have a value of 0) by AND'ing the one's complement of the value 0x01 shifted left by port_array_bit places.

To illustrate the operation of the modify_filter_value function, assume that an administrator directs the packet filter 308 to enable, for example, UDP port 1021 (port_number=1021, enable=TRUE). Using these values, in this example, port_array_index=127 and port_array_bit=5. Accordingly, the fifth bit of the entry at port_array[127 ] represents the status of port 1021. To enable this bit, the binary value of the entry at port_array[127 ](01101111b in this example) is OR'ed with the value of 0x01 shifted left five places (0x01 <<5=00010000b), resulting in the binary value 01111111b, with the value of the fifth bit changing from 0 to 1, indicating that port 1021 is enabled for the auto-connect process.

By representing the auto-connect status (i.e., enabled or disabled) for each port using a single bit rather than an eight-bit or larger integer, considerable memory space can be conserved. If the CPE 106 were to utilize UDP ports 0-1024 and TCP ports 0-1024, then 258 bytes could be used for a bit-based representation (1025 ports * 1 bit/8 bits per byte * 2 arrays). However, if a byte-based representation were utilized, then 2,050 bytes would be needed to represent the status of the 1025 UDP ports and the 1025 TCP ports. The memory conservation afforded by a bit-based representation increases as the number of available ports represented by the filter table 214 increases.

Although exemplary embodiments for the packet filter 308 and filter table 214 have been illustrated, other processes for filtering packets to prevent spurious attempts at automatically establishing a physical connection may be implemented without departing from the spirit or the scope of the present invention. For example, if memory consumption is relatively unimportant, the filter table 214 can be implemented as, for example, one or more arrays for each of the port types, where each array includes a separate entry for each port of the associated port type. Furthermore, rather than filtering the packets based on ports, the packet filter 308, in one embodiment, can be implemented at a higher-level protocol layer, such as the IP layer 304. In this case, the packet filter 308 could be adapted to determine the intended destination of a packet from the network device 102 by examining the destination IP address of the packet. If the destination IP address is associated with a device on the network 114, then the packet filter 308, in this case, can direct the auto-connect module 310 to automatically establish the physical connection. Conversely, if the destination IP address is associated with the CPE 106 or other local device, the packet filter 308 can bypass the automatic establishment of the physical connection since the packet is not intended for transmission to the access concentrator 112. Other processes for determining the intended destination of packets and then filtering the packets as appropriate can be developed by those skilled in the art, using the guidelines provided herein.

As described above, FIGS. 1-3 illustrate an exemplary system for providing a PPP auto-connect process at a CPE connecting a LAN to a WAN. The hardware portions of the CPE 106 (FIG. 1), such as the communications processor 204 (FIG. 2), may be in the form of a processing device, such as a microprocessor, microcontroller, application specific integrated circuit, or a programmable logic controller, for example. Similarly, the network protocol stack 206 (FIG. 2), in part or in whole, may be implemented as various forms of hardware, such as discrete logic, a programmable logic device, an application specific integrated circuit, or a combination thereof. Preferably, however, the network protocol stack 206 is implemented as a set of executable instructions (i.e., software) executed by the communications processor 204. The instructions may be either permanently or temporarily stored in the memory 208 of the CPE 106. The set of instructions may include various instructions that perform a particular task or tasks, such as those tasks described above with reference to the network protocol stack 206. Such a set of instructions for performing a particular task may be characterized as a program, software program, or simply software. The software may be in the form of, for example, system software or application software. The software might also be in the form of a collection of separate programs, a program module within a larger program, or a portion of a program module. The software used might also include modular programming in the form of object-oriented programming.

Further, it is appreciated that the instructions or set of instructions used in the implementation and operation of the invention may be in a suitable form such that the communications processor 204 may read the instructions. For example, the instructions that form a program may be in the form of a suitable programming language, which is converted to machine language or object code to allow the communications processor 204 to perform the instructions. That is, written lines of programming code or source code, in a particular programming language, are converted to machine language using a compiler, assembler or interpreter. The machine language is binary coded machine instructions that are specific to a particular type of processing device, i.e., to a particular type of computer, for example.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Other embodiments, uses, and advantages of the invention will be apparent to those skilled in the art from consideration of the specification and practice of the invention disclosed herein. The specification and drawings should be considered exemplary only, and the scope of the invention is accordingly intended to be limited only by the following claims and equivalents thereof.

1. In a distributed network including at least one local area network having a network device and a wide area network having an access concentrator, a customer premise access equipment comprising:
a first interface operatively connected to the network device and being adapted to receive at least one data packet from the network device;
a second interface operatively connected to the access concentrator and being adapted to provide at least one data packet to the access concentrator for transmission to the wide area network; and
an auto-connect module operably connected to the first interface and the second interface and being adapted to automatically establish a physical connection between the second interface and the access concentrator based at least in part on reception of a data packet intended for the wide area network by the customer premise access equipment.

2. The customer premise access equipment as in claim 1, further comprising a packet buffer adapted to:
store the data packet intended for the wide area network until the physical connection is established; and
provide the at least one packet to the second interface after the physical connection is established for transmission to the access concentrator over the physical connection.

3. The customer premise access equipment as in claim 1, further comprising a packet filter adapted to:
determine an intended destination of a packet received at the first interface based at least in part on a port used to receive the packet;
direct the auto-connect module to establish the physical connection when the intended destination is the wide area network; and
bypass the auto-connect module when the intended destination is the customer premise access equipment.

4. The customer premise access equipment as in claim 3, wherein the port used to receive the packet is representative of a network protocol associated with the packet.

5. The customer premise access equipment as in claim 3, wherein the packet filter is implemented as part of a Point-to-Point Protocol (PPP) layer of a network protocol stack.

6. The customer premise access equipment as in claim 1, wherein the customer premise access equipment is one of a group consisting of a DSL modem, a dial-up modem, an optical network termination, and a cable modem.

7. The customer premise access equipment as in claim 1, wherein the auto-connect module is implemented as part of a Point-to-Point Protocol (PPP) layer of a network stack.

8. In a communications processor for processing data transmitted between a network device of a local area network and an access concentrator of a wide area network, a network protocol stack comprising:
at least one higher-level protocol layer;
at least one lower-level protocol layer; and
a Point-to-Point Protocol (PPP) layer operably connected to the at least one higher-level protocol layer and the at least one lower-level protocol layer and being adapted to:
receive a data packet from the network device via the higher-level protocol layer;
determine an intended destination of the packet based at least in part on a port used to receive the packet from the network device; and
automatically establish a physical connection with the access concentrator when the wide area network is the intended destination of the packet.

9. The network protocol stack as in claim 8, wherein the PPP layer is further adapted to bypass an automatic establishment of a physical connection to the access concentrator when the intended destination is a protocol layer of the network protocol stack .

10. The network protocol stack as in claim 8, wherein the PPP layer is further adapted to:
store the packet in a buffer until the physical connection is established; and
provide the packet from the buffer to the lower-level protocol layer for transmission to the access concentrator when the physical connection is established.

11. The network protocol stack as in claim 8, wherein the PPP layer is adapted to determine the intended destination of the packet by retrieving a status value associated with the port from a filter table, the status value being representative of the intended destination of the packet.

12. The network protocol stack as in claim 11, wherein the filter table includes a plurality of entries, each entry corresponding to a status value of one of a plurality of available ports of the network protocol stack.

13. The network protocol stack as in claim 11, wherein the filter table includes a plurality of multiple-bit entries, each bit of each entry corresponding to a status value of one of a plurality of available ports of the network protocol stack.

14. The network protocol stack as in claim 8, wherein the network protocol stack is implemented in one of a group consisting of a DSL modem, a dial-up modem, an optical network termination, and a cable modem.

15. A method for communicating data from a network device of a local area network to an access concentrator of a wide area network using a customer premise access equipment, the method comprising the steps of:
receiving, at a port of the customer premise access equipment, a data packet from the network device;
determining an intended destination of the data packet based at least in part on the port; and
automatically establishing a physical connection between the customer premise access equipment and the access concentrator for transmission of the packet when the intended destination is the wide area network.

16. The method as in claim 15, further comprising the step of:
bypass an automatic establishment of a physical connection between the customer premise access equipment and the access concentrator when the intended destination is the customer premise access equipment.

17. The method as in claim 15, wherein the step of determining the intended destination includes retrieving a status value associated with the port from a filter table, the status value being representative of an intended destination of a data packet received via the port.

18. The method as in claim 17, wherein the filter table includes a plurality of status values, each status value representing an intended destination of a packet received at one of a plurality of available ports.

19. The method as in claim 18, wherein each of the plurality of status values is a binary value.

20. The method as in claim 15, further comprising the steps of:
storing the data packet until the physical connection is established; and
transmitting the data packet to the access concentrator over the established physical connection.

21. The method as in claim 15, wherein the customer premise access equipment is one of a group consisting of a DSL modem, a dial-up modem, an optical network termination, and a cable modem.

22. In a network protocol stack of a customer premise access equipment for processing data transmitted between a network device of a local area network and an access concentrator of a wide area network, the network protocol stack including at least a Point-to-Point Protocol (PPP) layer, a method comprising the steps of:
receiving, at the PPP layer, a data packet from the network device via a port of a higher-level protocol layer of the network stack;
determining, at the PPP layer, an intended destination of the first data packet based at least in part on the port; and
automatically establishing a physical connection between the customer premise access equipment and the access concentrator when the intended destination of the data packet is the wide area network.

23. The method as in claim 22, further comprising the step of bypassing an automatic establishment of a physical connection between the customer premise access equipment and the access concentrator when the intended destination of the data packet is the customer premise access equipment.

24. The method as in claim 22, further comprising the step of transmitting the data packet over the established physical connection.

25. The method as in claim 24, further comprising the step of buffering the data packet in a buffer until the physical connection is established.

26. The method as in claim 22, wherein the step of determining the intended destination includes retrieving a status value associated with the port from a filter table, the status value being representative of an intended destination of a data packet received via the port.

27. The method as in claim 26, wherein the filter table includes a plurality of status values, each status value representing an intended destination of a packet received at one of a plurality of available ports.

28. The method as in claim 27, wherein each of the plurality of status values is a binary value.

29. The method as in claim 22, wherein the customer premise access equipment is one of a group consisting of a DSL modem, a dial-up modem, an optical network termination, and a cable modem.

30. In a customer premise access equipment for processing data transmitted between a network device of a local area network and an access concentrator of a wide area network, a computer readable medium comprising a set of executable instructions adapted to manipulate a processor to:
receive a data packet from the network device via an available port of the customer premise access equipment;
determine an intended destination of the first data packet based at least in part on the port; and
automatically establish a physical connection between the customer premise access equipment and the access concentrator when the intended destination of the data packet is the wide area network.

31. The computer readable medium as in claim 30, wherein the set of executable instructions further includes instructions to manipulate the processor to bypass an automatic establishment of a physical connection between the customer premise access equipment and the access concentrator when the intended destination of the data packet is the customer premise access equipment.

32. The computer readable medium as in claim 30, wherein the set of executable instructions further includes instructions to manipulate the processor to provide the data packet for transmission over the established physical connection.

33. The computer readable medium as in claim 32, wherein the set of executable instructions further includes instructions to manipulate the processor to buffer the data packet in a buffer until the physical connection is established.
